(19) United States
(12) Patent Application Publication
(10) Pub. No.: US 2025/0272534 A1
(43) Pub. Date: Aug. 28, 2025

(54) ADVANCED SYSTEMS AND METHODS FOR MULTIMODAL AI: GENERATIVE MULTIMODAL LARGE LANGUAGE AND DEEP LEARNING MODELS WITH APPLICATIONS ACROSS DIVERSE DOMAINS

(71) Applicant: UNIVERSITY OF MIAMI, Miami, FL (US)

(72) Inventors: Phuong Nguyen, Miami, FL (US); Yelena Yesha, Miami, FL (US); Kevin Padron, Miami, FL (US)

(21) Appl. No.: 19/056,124

(22) Filed: Feb. 18, 2025

Related U.S. Application Data
(60) Provisional application No. 63/557,147, filed on Feb. 23, 2024.

(51) Int. Cl. G06N 3/042; G06F 16/435; G06N 3/0475; G06N 3/092

(52) U.S. Cl. CPC G06N 3/042; G06F 16/435; G06N 3/0475; G06N 3/092

(57) ABSTRACT

Systems and methods are provided for improving generative artificial intelligence (AI). Systems and methods can integrate more reliable data sources and enhance generative AI training and inference processes for complex tasks. The integration of real-time data and expert input can be included as crucial steps in aligning AI outputs with improved accuracy. Similarly, fine-tuning methodologies and augmentation algorithms can be used to focus on minimizing the occurrence of fabricated content, thereby significantly increasing the chances that the information generated is both current and credible.

### CROSS-REFERENCE TO RELATED APPLICATION

This application claims the benefit of U.S. Provisional Application Ser. No. 63/557,147, filed Feb. 23, 2024, the disclosure of which is hereby incorporated by reference in its entirety, including all figures, tables, and drawings.

### BACKGROUND

In the domain of generative artificial intelligence (AI), the current landscape is one where the potential for innovation is immense, yet is fraught with the significant challenge of ensuring AI reliability. As these generative AI models are tasked with producing increasingly sophisticated outputs, even incorporating multiple modalities like imaging and audio, a notable concern is their propensity to generate what is often referred to as “hallucinated” content. Such content, although it may appear cogent, is not grounded in verifiable data or reality. In fields that rely heavily on the accuracy and precision of information—such as medicine, law, or pharmaceutical research—the repercussions of such inaccuracies can be profound. In these expert domains, where the cost of misinformation can be high, the reliability of AI-generated content has become a pressing concern, impeding the trust and adoption of such technology even in scenarios where generative AI could have high proficiency.

### BRIEF SUMMARY

In order to address the concerns mentioned in the Background section, embodiments of the subject invention provide novel and advantageous systems and methods for generative artificial intelligence (AI). Systems and methods can integrate more reliable data sources and enhance generative AI training and inference processes for complex tasks. The integration of real-time data and expert input can be included as crucial steps in aligning AI outputs with improved accuracy. Similarly, fine-tuning methodologies and augmentation algorithms can be used to focus on minimizing the occurrence of fabricated content, thereby significantly increasing the chances that the information generated is both current and credible. This marks a shift toward creating AI systems that are not only powerful in their generative capabilities, but also trustworthy in their outputs. Embodiments of the subject invention allow for AI applications that can be confidently utilized in highly-specialized fields, where decisions hinge on the validity of the information provided.

In an embodiment, a system for training and inference of a generative AI model (e.g., a subject matter expert generative AI model) can comprise a processor and a (non-transitory) machine-readable medium in operable communication with the processor and having instructions stored thereon that, when executed by the processor, perform the following steps: a) training a generative multi-modal large language model (GM-LLM) using a first dataset to obtain a trained GM-LLM, wherein the first dataset has been processed using a contextual fusion for enhanced image-text retrieval (CFEITR) algorithm to synthesize features across a plurality of modalities using a fusion and cross-attention layer, thereby obtaining the trained GM-LLM with an improved contextual understanding of text input, image input, video input, and audio input (the first dataset may comprise collected data of a plurality of modalities); b) performing fine-tuning on the trained GM-LLM using a task-specific meta-learning algorithm (TSML) to obtain a fine-tuned GM-LLM, which can be configured (and/or optimized) for expert-driven augmentation and active learning; and c) performing an inference process on the fine-tuned GM-LLM (e.g., using knowledge graph-enhanced retrieval and a Bayesian active reinforcement learning for multi-modal improvement (BARMI) algorithm to dynamically validate outputs against at least one expert rule set and/or at least one knowledge base) to obtain the generative AI model, which can be capable of generating outputs (e.g., accurate subject matter expert outputs) based on multi-modal input data. The first dataset can be a subject matter expert dataset. The instructions when executed can further perform the following step: processing of the first dataset using a multi-modal data processing unit (MM-DPU); this can be performed, e.g., before step a), such that the training of the GM-LLM can be done using the first dataset after processing by the MM-DPU. The performing of the fine-tuning with the TSML can comprise using the TSML with subject matter expert augmentation via vector searching and ranking methods incorporating assurance and validation to obtain specific fine-tuned subject matter expert GM-LLM task models. The instructions when executed can further perform the following step: performing a knowledge validation to apply a set of algorithms to search, index, and verify outputs of the generative AI model against established knowledge graphs and expert rulesets; this can be performed, e.g., between steps b) and c), such that the inference process done using the fine-tuned GM-LLM after performing the knowledge validation. The performing of the inference process can comprise performing an inference process on the fine-tuned GM-LLM with expert knowledge graphs, expert ruleset checking, and truth grounding via Bayesian Active Reinforcement Learning to obtain the generative AI model that is capable of generating outputs (e.g., accurate subject matter expert outputs) based on multi-modal input data. The plurality of modalities can comprise one or more of text, image, video, and audio. The instructions when executed can further perform the following step: d) before step c), incorporating an adaptive retrieval mechanism into the GM-LLM, the trained GM-LLM, or the fine-tuned GM-LLM, wherein the adaptive retrieval mechanism is configured to query both static knowledge bases and dynamic, real-time data sources. The adaptive retrieval mechanism can be further configured to: re-rank responses using a multi-layered relevance scoring system; and/or filter outputs using domain-specific constraints and expert rules. The adaptive retrieval mechanism can be implemented using a retrieval augmented generation (RAG) architecture (e.g., with searching and indexing algorithms). The RAG architecture can comprise a dynamic query expansion model, multi-modal contrastive retrieval techniques, and/or task-adaptive embeddings for knowledge search. The instructions when executed can further perform the following step: c) before step a), using the CFEITR algorithm on the first dataset to extract cross-modality semantic feature, to filter training inputs using multi-modal consistency validation, and/or to obtain a context-aware first dataset, which is used for training the GM-LLM in step a). The CFEITR algorithm can comprise a fusion and cross-attention layer that synthesizes important features from different modalities in the first dataset. Step a) can comprise using an expert augmentation and feedback loop, and human expert feedback can be incorporated using an interactive Bayesian active reinforcement learning framework to iteratively improve a multimodal understanding of the GM-LLM and performance metrics of the GM-LLM. Step a) can comprise using an output validation and assurance module (OVAM) that validates AI-generated outputs against established criteria. The instructions when executed can further perform the following step: f) providing connectivity to a plurality of database systems using a database integration module (DIM) via a unified application programming interface (API). The instructions when executed can further perform the following step: g) providing a real-time streaming connector (RTSC) that provides access to real-time data feeds. The instructions when executed can further perform the following step: h) providing a knowledge graph navigator (KGN) that enables the generative AI model to traverse through a plurality of knowledge graphs. The instructions when executed can further perform the following step: i) creating content of the plurality of knowledge graph based on user input and expert knowledge rule sets. Step b) can comprise using the BARMI algorithm to actively train and/or fine-tune the (trained) GM-LLM in real time with new data (e.g., new subject matter expert data) and expert feedback. Step b) can comprise using a Bayesian analysis algorithm utilizing statistical techniques (e.g., maximum likelihood statistical techniques) to fine-tune and/or optimize the trained GM-LLM based on performance metrics and user feedback. Step b) can comprise using an expert ruleset verification layer that aligns outputs of the generative AI model with a set of pre-defined expert rules or standards. The instructions when executed can further perform the following step: j) using a relevance scoring and rewarding algorithm (e.g., a relevance scoring and multiple objective rewarding algorithm), and the relevance scoring and rewarding algorithm can combine semantic similarity metrics, contextual relevance weights, and/or a reinforcement learning reward system to optimize outputs of the generative AI model in response to user queries. The instructions when executed can further perform the following step: k) using a distributed query execution module to handle execution of queries to the generative AI model across a plurality of databases (e.g., by parallelizing multi-source queries across structured and unstructured datasets, and optimizing response latency using adaptive load balancing). The instructions when executed can further perform the following step: l) using a real-time data pre-processor to condition streaming data for immediate input into the generative AI model. The system can further comprise a (non-transitory) storage memory in operable communication with the processor, the machine-readable medium, or both. The instructions when executed can further perform the following step: m) using a stream-to-database transfer manager to transfer real-time data into the storage memory. The instructions when executed can further perform the following step: n) using a knowledge validation layer to apply a set of algorithms to search, index, and/or verify outputs of the generative AI model against established knowledge graphs and expert rulesets.

In another embodiment, a method for training and inference of a generative AI model (e.g., a subject matter expert generative AI model) can comprise: a) training (e.g., by a processor) a GM-LLM (e.g., a subject matter expert GM-LLM) using a first dataset (e.g., a subject matter expert dataset) to obtain a trained GM-LLM, wherein the first dataset has been processed using a CFEITR algorithm to synthesize features across a plurality of modalities using a fusion and cross-attention layer, thereby obtaining the trained GM-LLM with an improved contextual understanding of text input, image input, video input, and audio input (the first dataset may comprise collected data of a plurality of modalities); b) performing (e.g., by the processor) fine-tuning on the trained GM-LLM using a TSML to obtain a fine-tuned GM-LLM, which can be configured (and/or optimized) for expert-driven augmentation and active learning; and c) performing (e.g., by the processor) an inference process on the fine-tuned GM-LLM (e.g., using knowledge graph-enhanced retrieval and a BARMI algorithm to dynamically validate outputs against at least one expert rule set and/or at least one knowledge base) to obtain the generative AI model, which can be capable of generating outputs (e.g., accurate subject matter expert outputs) based on multi-modal input data. The first dataset can be a subject matter expert dataset. The method can further comprise: processing of the first dataset using a multi-modal data processing unit (MM-DPU); this can be performed, e.g., before step a), such that the training of the GM-LLM can be done using the first dataset after processing by the MM-DPU. The performing of the fine-tuning with the TSML can comprise using the TSML with subject matter expert augmentation via vector searching and ranking methods incorporating assurance and validation to obtain specific fine-tuned subject matter expert GM-LLM task models. The method can further comprise: performing a knowledge validation to apply a set of algorithms to search, index, and verify outputs of the generative AI model against established knowledge graphs and expert rulesets; this can be performed, e.g., between steps b) and c), such that the inference process done using the fine-tuned GM-LLM after performing the knowledge validation. The performing of the inference process can comprise performing an inference process on the fine-tuned GM-LLM with expert knowledge graphs, expert ruleset checking, and truth grounding via Bayesian Active Reinforcement Learning to obtain the generative AI model that is capable of generating outputs (e.g., accurate subject matter expert outputs) based on multi-modal input data. The plurality of modalities can comprise one or more of text, image, video, and audio. The method can further comprise: d) before step c), incorporating (e.g., by the processor) an adaptive retrieval mechanism into the GM-LLM, the trained GM-LLM, or the fine-tuned GM-LLM, wherein the adaptive retrieval mechanism is configured to query both static knowledge bases and dynamic, real-time data sources. The adaptive retrieval mechanism can be further configured to: re-rank responses using a multi-layered relevance scoring system; and/or filter outputs using domain-specific constraints and expert rules. The adaptive retrieval mechanism can be implemented using a RAG architecture (e.g., with searching and indexing algorithms). The RAG architecture can comprise a dynamic query expansion model, multi-modal contrastive retrieval techniques, and/or task-adaptive embeddings for knowledge search. The method can further comprise: c) before step a), using (e.g., by the processor) the CFEITR algorithm on the first dataset to extract cross-modality semantic feature, to filter training inputs using multi-modal consistency validation, and/or to obtain a context-aware first dataset, which is used for training the GM-LLM in step a). The CFEITR algorithm can comprise a fusion and cross-attention layer that synthesizes important features from different modalities in the first dataset. Step a) can comprise using (e.g., by the processor) an expert augmentation and feedback loop, and human expert feedback can be incorporated using an interactive Bayesian active reinforcement learning framework to iteratively improve a multimodal understanding of the GM-LLM and performance metrics of the GM-LLM. Step a) can comprise using (e.g., by the processor) an OVAM that validates AI-generated outputs against established criteria. The method can further comprise: f) providing (e.g., by the processor) connectivity to a plurality of database systems using a DIM via a unified API. The method can further comprise: g) providing (e.g., by the processor) a RTSC that provides access to real-time data feeds. The method can further comprise: h) providing (e.g., by the processor) a KGN that enables the generative AI model to traverse through a plurality of knowledge graphs. The method can further comprise: i) creating (e.g., by the processor) content of the plurality of knowledge graph based on user input and expert knowledge rule sets. Step b) can comprise using (e.g., by the processor) the (or a) BARMI algorithm to actively train and fine-tune the GM-LLM in real time with new data and expert feedback. Step b) can comprise using (e.g., by the processor) a Bayesian analysis algorithm utilizing statistical techniques (e.g., maximum likelihood statistical techniques) to fine-tune and/or optimize the trained GM-LLM based on performance metrics and user feedback. Step b) can comprise using (e.g., by the processor) an expert ruleset verification layer that aligns outputs of the generative AI model with a set of pre-defined expert rules or standards. The method can further comprise: j) using (e.g., by the processor) a relevance scoring and rewarding algorithm (e.g., a relevance scoring and multiple objective rewarding algorithm), and the relevance scoring and rewarding algorithm can combine semantic similarity metrics, contextual relevance weights, and/or a reinforcement learning reward system to optimize outputs of the generative AI model in response to user queries. The method can further comprise: k) using (e.g., by the processor) a distributed query execution module to handle execution of queries to the generative AI model across a plurality of databases (e.g., by parallelizing multi-source queries across structured and unstructured datasets, and optimizing response latency using adaptive load balancing). The method can further comprise: l) using (e.g., by the processor) a real-time data pre-processor to condition streaming data for immediate input into the generative AI model. The method can further comprise: m) using (e.g., by the processor) a stream-to-database transfer manager to transfer real-time data into a storage memory (e.g., a storage memory in operable communication with the processor). The method can further comprise: n) using (e.g., by the processor) a knowledge validation layer to apply a set of algorithms to search, index, and/or verify outputs of the generative AI model against established knowledge graphs and expert rulesets.

### BRIEF DESCRIPTION OF DRAWINGS

FIG. 1 shows the high-level architecture of a system for generative artificial intelligence (AI), according to an embodiment of the subject invention.

FIG. 2 shows a chart of a dynamic interaction interface in which a user interacts and data pre-processing occurs, according to an embodiment of the subject invention.

FIG. 3 shows a flow chart of data processing that can be used with systems and methods of embodiments of the subject invention.

FIG. 4 shows a relevance scoring algorithm, which quantifies the alignment between user queries and the result, and which can be used with systems and methods of embodiments of the subject invention.

FIG. 5 shows a flow chart of a contextual fusion for enhanced image-text retrieval (CFEITR) algorithm, which can be used with systems and methods of embodiments of the subject invention.

FIG. 6 shows a flow chart of a Bayesian active reinforcement learning for multi-modal improvement (BARMI) algorithm, which can be used with systems and methods of embodiments of the subject invention.

FIG. 7 shows an expectation-maximization (EM) algorithm, which can be used with systems and methods of embodiments of the subject invention.

FIG. 8 shows a task-specific meta-learning (TSML) algorithm, which dynamically optimizes model adaptation and improves task-specific fine-tuning, and which can be used with systems and methods of embodiments of the subject invention.

### DETAILED DESCRIPTION

Embodiments of the subject invention provide novel and advantageous systems and methods for generative artificial intelligence (AI). Systems and methods can integrate more reliable data sources and enhance generative AI training and inference processes for complex tasks. The integration of real-time data and expert input can be included as crucial steps in aligning AI outputs with improved accuracy. Similarly, fine-tuning methodologies and augmentation algorithms can be used to focus on minimizing the occurrence of fabricated content, thereby significantly increasing the chances that the information generated is both current and credible. This marks a shift toward creating AI systems that are not only powerful in their generative capabilities, but also trustworthy in their outputs. Embodiments of the subject invention allow for AI applications that can be confidently utilized in highly-specialized fields, where decisions hinge on the validity of the information provided.

Embodiments of the subject invention can utilize sophisticated Generative Multi-modal Large Language Models (GM-LLMs), which can be fine-tuned for applications across various sectors such as healthcare, radiology, chemistry, pharmaceuticals, and supply chain logistics. The system/method can be uniquely tailored for specific tasks, employing an innovative instruction fine-tuning mechanism, advanced analytics, and data-efficient alignment for high accuracy data processing. Systems and methods can implement retrieval augmented generation (RAG) architectures, enhanced with adaptive retrieval and augmentation systems, to meet diverse domain requirements and ensure data relevance. Systems and methods of embodiments of the subject invention can facilitate real-time connectivity to an innovative augmentation processing pipeline, which can include domain-specific resources (e.g., expert knowledge graphs, external data, and expert-augmented resources), which can be merged with one or more pre-trained models. Methodologies can be used for the accurate retrieval of relevant knowledge, the generation of augmentation data, and/or the safeguarding of model responses through safety filters and quality assessment metrics.

AI systems have evolved beyond traditional data processing, necessitating innovations in how models interact with complex and even multi-modal data, especially in highly-specialized domains. Addressing the intricate challenges of domain-specific tasks, systems and methods of embodiments of the subject invention (which can be referred to herein as the Universal Expert AI (U-AI) system or method) deliver tailored advancements in the field of generative AI. Multiple sophisticated methods can be incorporated for the training, inference, fine-tuning, and/or expert guidance of GM-LLMs for applications across various sectors, such as healthcare, radiology, chemistry, pharmaceuticals, and supply chain logistics. Systems and methods can be uniquely tailored for complex tasks, employing innovative methods for training, fine-tuning, and/or data-efficient alignment for high-accuracy data processing. Multiple mechanisms can be implemented for truth-grounding, including knowledge-enhanced adaptive retrieval mechanisms for querying knowledge bases and/or real-time data sources to meet diverse domain requirements and ensure data relevance. The U-AI system/method offers a robust and specialized solution for generative AI applications, representing a significant advancement towards achieving expert-level accuracy and reliability in various sectors, including healthcare, radiology, chemistry, pharmaceuticals, supply chain logistics, and beyond.

The U-AI systems/methods are specifically designed to address the inherent complexities of domain-specific tasks, presenting a solution for generative AI applications. Unique methods and/or advanced algorithms can be used, including retrieval mechanisms enhanced with adaptive algorithms and/or expert augmentation systems. The U-AI systems/methods operate across various sectors with a remarkable degree of accuracy and efficiency. Systems and methods allow for real-time connectivity to an augmentation processing pipeline that includes domain-specific resources (e.g., expert knowledge graphs, external data sources, and/or expert-augmented fine-tuning with pre-trained models).

Real-time data sources can serve as a foundational layer of truth for the U-AI systems/methods. By maintaining a dynamic connection to up-to-date data stores and employing methodologies for the accurate retrieval of relevant knowledge, it can be ensured that the knowledge base is both relevant and continually updated, a critical feature in fields like healthcare where data evolves rapidly.

Expert knowledge sources, such as knowledge graphs, ontologies, and curated rule sets, can be used to provide another layer of factual scaffolding. These resources can be integrated into the systems and methods of embodiments of the subject invention to encode the expertise and consensus of domain authorities in a structured form that the AI model(s) can use to validate and enhance the output(s), also enabling the generation of domain-specific augmentation data to ensure relevance. Embodiments are particularly advantageous in areas with complex concepts and terminologies, such as medicine, law, and pharmaceuticals.

Embodiments of the subject invention can also incorporate one or more specialized algorithms, including contextual fusion for enhanced image-text retrieval (CFEITR) and Bayesian active reinforcement learning for multi-modal improvement (BARMI). These advanced methods can empower the AI models to retrieve and understand multi-modal data and actively learn from expert feedback, thereby aligning the AI's outputs with the high standards expected by professionals in various fields while also implementing safety filters and quality assessment metrics to safeguard model responses.

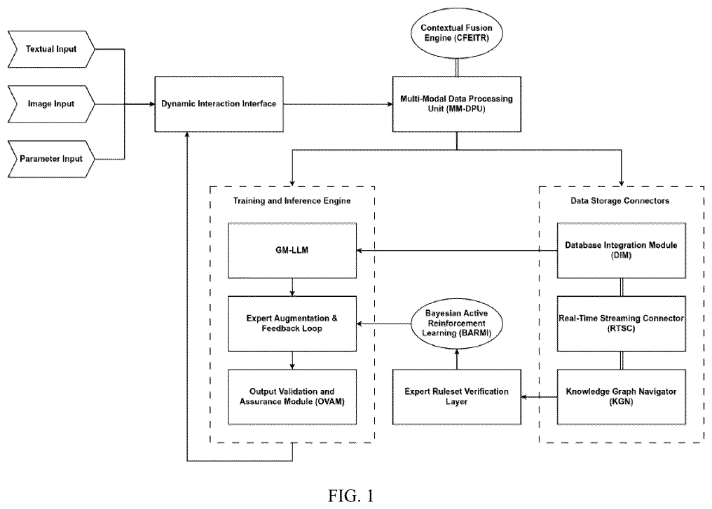

FIG. 1 shows the high-level architecture of a system for generative AI, according to an embodiment of the subject invention. The overarching structure of the U-AI system is illustrated, showing the integration of multi-modal inputs, core AI processing, and output mechanisms. Referring to FIG. 1, the system can include user inputs, a dynamic interaction interface, a multi-modal data processing unit (MM-DPU), a contextual fusion engine (CFEITR engine), a training and interface engine, data storage connectors, a BARMI mechanism, and/or an expert ruleset verification layer.

The user input can be textual (e.g., commands, free-text, queries, and/or other types of textual data input by the user), media (e.g., images (two-dimensional (2D) and/or three-dimensional (3D)), videos, and/or any non-textual multimedia data), and/or parameter (e.g., additional input parameters that could influence the processing or results). The dynamic interaction interface can serve as the user's point of contact with the U-AI system, designed to handle complex, multi-faceted inquiries. It can take in different modalities of input (e.g., textual, media, and/or parameters) and forward them to the system for processing. The MM-DPU can be responsible for processing different types of data (e.g., text, media, and/or parameter) and can be connected directly to the dynamic interaction interface, handling immediate data processing tasks upon user interaction. The CFEITR engine can be used for combining or fusing data from different modalities, providing context-aware results. The training and inference engine can include: a core model (labeled “GM-LLM” in FIG. 1) for input reasoning, task following, and ultimately final output based on the combination of user input, data augmentation, and expert knowledge; an expert augmentation and feedback loop, which is the mechanism to incorporate expert feedback into the system for improving model accuracy and adherence to complex tasks; and an output validation and assurance module (OVAM), which ensures the output is validated and meets standards or criteria of downstream tasks before being presented as output to the user. The data storage connectors can include: a database integration module (DIM) that acts as a versatile database adapter, providing a seamless interface for connecting to various database systems through a unified application program interface (API); a real-time streaming connector (RTSC) that allows for real-time data streaming, for real-time data feeds or updates; and a knowledge graph navigator (KGN), which is a system component for navigating through knowledge graphs to provide context and relations between different data points. The BARMI mechanism is an advanced learning mechanism used for actively training the system with new data and expert feedback. The expert ruleset verification layer can ensure that the output or results align with a set of expert-defined rules or standards.

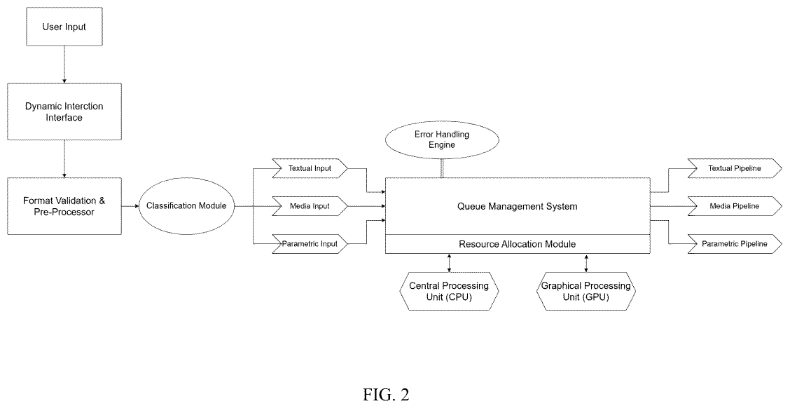

Referring to FIG. 2, a dynamic interaction interface can integrate an advanced input classification mechanism that detects and categorizes incoming data streams based on their respective type and intrinsic characteristics. This mechanism can ensure that inputs are directed to the appropriate processing pipeline, thereby facilitating accurate and efficient handling. The system can be capable of distinguishing (or configured to distinguish) textual inputs, such as natural language commands and queries, media inputs (including voice, audio, images, and video), and parametric inputs that encompass system control parameters and user-defined preferences.

Upon receiving an input, the interface can proceed to the format validation step, where the structure, compatibility, and completeness of the incoming data can be verified against predetermined format criteria. This step can serve as a safeguard against errors by identifying corrupted or incompatible inputs early in the process, optimizing the system's reliability and stability. Inputs that do not meet the required standards can either be flagged or rejected, preventing or inhibiting downstream processing errors.

Following classification and validation, the interface can engage in pre-processing operations. At this stage, the system can perform necessary transformations to prepare the input for subsequent processing. These transformations can include resizing or reformatting images, converting codecs, normalizing textual data, and/or extracting relevant parameters from various input streams.

To address high rates of simultaneous input, the dynamic interaction interface can incorporate queue management, as depicted in FIG. 2. This mechanism can organize and prioritize data streams based on factors such as urgency, input complexity, system workload, and/or resource availability. High-priority inputs can be processed promptly, while others can be systematically queued to ensure orderly and uninterrupted system operation.

Resource allocation can be dynamically performed through the interface's resource allocation module. The system can efficiently assign computational resources to meet specific input processing demands across graphical processing units (GPUs) and central processing units (CPUs). Through dynamic balancing and resource distribution, the interface can ensure optimal performance and effective utilization of available computational power.

The dynamic interaction interface can also be equipped with an error handling module, designed to address errors encountered during input processing. In such cases, the interface can promptly identify the issue, notify the user and/or system administrator, and/or attempt to resolve the error through predefined recovery procedures. In the case that manual intervention is required, the system can provide a clear report of the issue, ensuring that errors are addressed with minimal disruption to system operations.

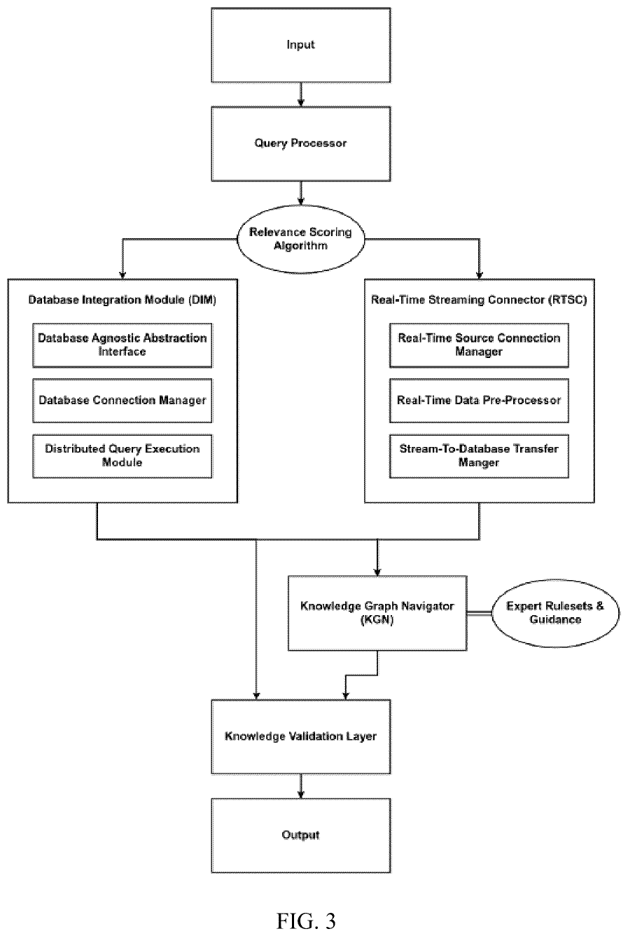

FIG. 3 shows a flow chart of data processing that can be used with systems and methods of embodiments of the subject invention. Data handling is shown from initial input through query processing, relevance assessment, and integration with databases and real-time systems, culminating in knowledge validation and output generation.

Referring to FIG. 3, the input box represents the initial query entry point where the queries are introduced into the connector. The query processor receives the input and processes the query, parsing, cleaning, and/or formatting of the input for usage in the system. The relevance scoring algorithm evaluates the input query to fetched results to determine the relevance, scoring them based on how well they match the query criteria. The database integration module (DIM) can include: a database agnostic abstraction interface that allows the system to interface with various databases without needing database-specific coding; a database connection manager that manages the connections to different databases, handling the logistics of connecting, disconnecting, and maintaining database sessions; and/or a distributed query execution module that handles the execution of queries across distributed databases and systems. The real-time streaming connector (RTSC) can include: a real-time source connection manager that manages connections to real-time data sources; a real-time data pre-processor that processes streaming data in real time, preparing it for integration or analysis; and/or a stream-to-database transfer manager that manages the transfer of data from the streaming sources into a database system. The knowledge graph navigator (KGN): is a component that allows for the traversal of a knowledge graph to enhance the context and relationships among data. The expert rulesets and guidance block refers to a set of algorithms that provide expert knowledge and rules for the system to follow, ensuring that outputs are consistent with domain-specific standards and practices. The knowledge validation layer can validate the output against the knowledge graph and/or expert rules to ensure accuracy and consistency. The output block represents the final result or answer produced by the system/method after the input has been through all the previous processes and validations, ready for presentation or further use.

The KGN can utilize advanced graph traversal algorithms that prioritize nodes and edges based on assigned weights, where each weight reflects the relevance and recency of the associated data. Specifically, a weighted graph traversal strategy can ensure that the most pertinent and up-to-date information is accessed first, a feature that is critical in applications requiring timeliness and accuracy. The traversal weights can be determined dynamically through a tunable formula, as follows:

$$w ( v , e ) = α \cdot relevance ( v ) + β \cdot recency ( e ) + γ queryintent$$

where α, β, and γ are adjustable parameters, v represents nodes, e represents edges, and the query intent incorporates user context and domain-specific constraints. By leveraging pre-trained language models, the system can adapt the traversal weights in real-time, ensuring a personalized and context-aware navigation of the knowledge graph.

For instance, in a medical diagnosis scenario, the KGN can traverse a dynamically weighted medical knowledge graph to align patient symptoms with the latest medical ontologies and research updates. This process can ensure that diagnostic suggestions remain current and contextually relevant, accounting for the latest clinical findings and patient-specific conditions.

To maintain the integrity and consistency of the graph during updates, the KGN can employ a graph sketch validation mechanism. This validation approach involves creating hashed representations—or “data sketches”—of both the baseline and updated graphs, denoted as S_{baseline} and S_{updated}, respectively. The difference between these representations can be calculated as follows:

$$Δ S = ‖ {S}_{updated} - {S}_{baseline} ‖$$

where ∥⋅∥ represents a norm function that quantifies the divergence between the two graph sketches. If the computed ΔS exceeds a predefined threshold δ, the update is flagged as potentially invalid, triggering either an automatic reversion to the prior state or a review process. This review can be conducted by human experts or pre-trained AI models capable of assessing (or configured to assess) the validity of changes. This can allow the KGN to prevent or inhibit the propagation of erroneous or outdated information within the graph, an essential safeguard in sensitive fields such as healthcare.

The combination of dynamic weighted traversal and robust validation can ensure that the KGN provides timely, accurate, and trustworthy information. This can enable the system to uncover meaningful relationships in complex data environments while maintaining consistency and integrity across frequent updates.

The system can additionally employ re-ranking techniques to refine the initial search results or outputs. This process involves identifying the most pertinent data that matches the user's query, assessing the quality and relevance of these results through sophisticated algorithms.

Re-ranking algorithms can consider factors such as semantic similarity and contextual importance, re-ordering the results to present the most relevant and accurate information to the following modules in the algorithm. This can ensure that the system's output aligns closely with user expectations.

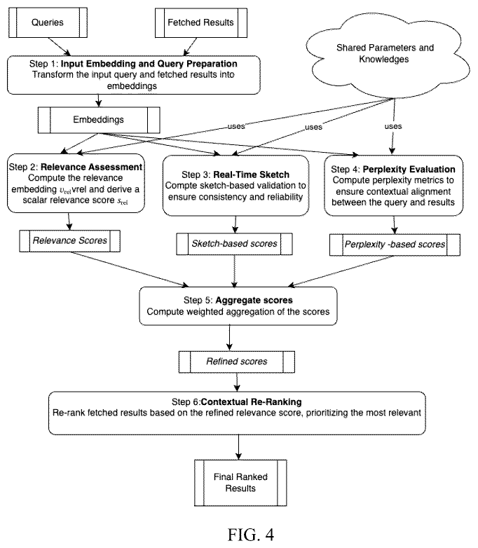

To accomplish this, as demonstrated in FIG. 4, the relevance scoring algorithm can assign a relevance score to each fetched result based on multiple contributing factors, quantifying the alignment between the query and the result. The process can begin with transforming the query q and the fetched results r into vector embeddings E_{q} and Eᵣ using a pre-trained language model. These embeddings can serve as dense, context-aware representations, capturing semantic nuances and ensuring a high-fidelity comparison between the input query and the results.

Once these embeddings are generated, an initial relevance assessment can be performed to derive a contextual embedding vᵣₑₗ, which represents the alignment between the query and the candidate result. This embedding can be processed using a linear assessment function, producing an initial scalar relevance score sᵣₑₗ as follows:

sᵣₑₗ=Assess(vᵣₑₗ)

Here, Assess(⋅) leverages pre-trained shared parameters and integrates external knowledge to highlight both semantic and structural relevance. To validate the accuracy and integrity of these results, the system can employ sketch-based validation. This method can generate compact representations (which can be referred to as “data sketches”) for the query and results using hashing techniques. A sketch similarity score, SketchSim(q, r), can be computed to ensure alignment between the query and the results, quickly detecting discrepancies or validation issues.

Further adjustment of the relevance score can be guided by perplexity-based analysis, which measures the contextual compatibility of a result r when conditioned on the query q. The perplexity P(r|q) can quantify the fluency and contextual coherence of the candidate result, as follows:

$$P ( r ∨ q ) = exp ( \frac{- 1}{n} {\sum }_{i = 1}^{n} log p ( {w}_{i} ∨ {w}_{1} , … , {w}_{i - 1} , q ) )$$

Lower perplexity values indicate greater contextual alignment between the query and the result, providing an additional signal for enhancing the relevance score. The system can integrate these contributing factors-semantic similarity, sketch validation, and perplexity-into a final relevance score R(q, r), computed as a weighted combination, as follows:

$$R ( q , r ) = α \cdot {s}_{r e l} + β \cdot SketchSim ( q , r ) - γ \cdot P ( r ∨ q )$$

The weights α, β, γ are tunable parameters that balance the contributions of each component, and they can be dynamically learned and optimized based on historical data, ensuring adaptability and improved performance over time. The computed scores can then be employed in the contextual re-ranking process, which reorganizes the fetched results by prioritizing those with the highest relevance scores. This re-ranking incorporates deeper contextual analysis, ensuring a more robust alignment with the user's query.

The system can use the computed relevance scores to re-rank the fetched results, prioritizing those with higher scores and presenting the user with the most pertinent results first. By integrating contextual factors such as semantic similarity and real-time sketch validation, the re-ranking process can ensure a robust alignment with user expectations. A hybrid method including re-ranking and cross-encoder models can refine the results of an initial retrieval step through a deeper evaluation of the relevance between queries and fetched results.

An initial set of k candidates {c₁, c₂, . . . , cₖ} can be retrieved using a lightweight retrieval method, such as BM25 (Best Match 25) or dense retrieval. A cross-encoder can then process each query-candidate pair (q, cᵢ) jointly, evaluating their compatibility by considering the entire text, as follows:

$${R ( q , r )}_{i} = {f}_{cross - encoder} ( q , {c}_{i} ; θ )$$

where R(q,r)ᵢ represents the relevance score for candidate cᵢ. The cross-encoder can be trained to minimize a ranking loss, such as the pairwise hinge loss. This method can provide fine-grained relevance scoring by jointly encoding queries and candidates, improving the quality of the top-ranked fetched results in the system.

The DIM can play a vital role in expanding the system's knowledge base. By integrating with external databases, the DIM can provide access to a vast reservoir of data, both structured and unstructured. This intelligent data integration can allow the U-AI system to leverage external data for more comprehensive analysis, enriching its processing capabilities with real-world, up-to-date information.

The real-time streaming connector is designed to handle dynamic data integration from real-time streams. This connector can enable the U-AI system to process, analyze, and respond to data as it arrives, rather than relying solely on historical or batch-processed data. The RTSC can ensure that the system remains current with evolving data sources, providing timely results and insights. Within the RTSC, stream-to-sketch processing can further enhance real-time capabilities. This process can involve dynamically generating data sketches from incoming data streams. These sketches can then be used for validation, analysis, and integration with other system components, allowing for real-time decision-making and processing without the need for storing the entire data stream. This approach can optimize resource usage while maintaining the system's responsiveness to dynamic data environments.

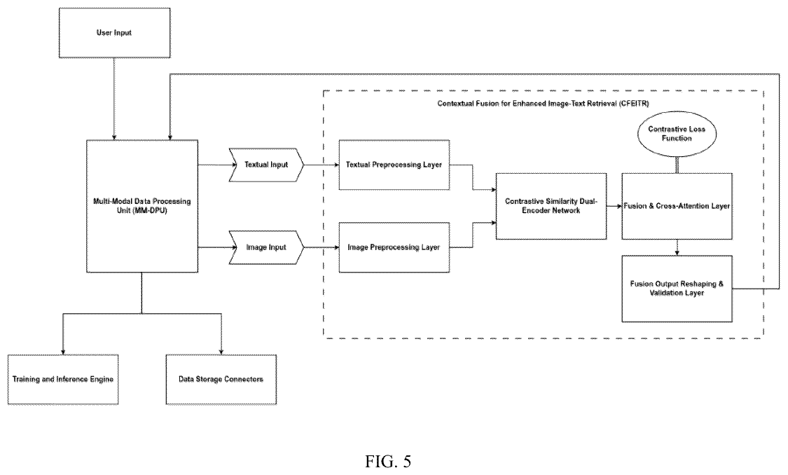

FIG. 5 shows a flow chart of a CFEITR algorithm, which can be used with systems and methods of embodiments of the subject invention. The flow is depicted from user input through multi-modal data processing, detailing the preprocessing, encoding, and fusion layers involved.

Referring to FIG. 5, the algorithm can initially take in different modalities of user input (e.g., textual, media, and/or optional parameters) and forward them to the system for processing. The MM-DPU is central to the system's capability to process different types of input data of different modalities. The MM-DPU can facilitate the forwarding of the data for further analysis and processing, as well as incorporate both initial user input data and the processed data part of the contextual fusion loop. The textual input and image input blocks represent that there are two dedicated pathways for different data types from the MM-DPU. The textual preprocessing layer can handle textual input data processing to standardize and prepare it for fusion, and the image preprocessing layer can handle image input data processing to standardize and prepare it for fusion. The CFEITR engine (the CFEITR block in FIG. 5) is a major component for enhancing model ability to correlate images and text accurately and it can include: a contrastive similarity dual-encoder network that is employed to process both text and image data in parallel, learning to map the inputs into a common feature space where they can be directly compared or related; a contrastive loss function that trains the system to learn to distinguish between different inputs effectively; a fusion and cross-attention layer that is a mechanism where the processed text and image data are combined, and the system is allowed to attend to important features from both inputs for accurate information retrieval and decision-making; and/or a fusion output reshaping and validation layer in which combined data is formatted appropriately for output and undergoes a validation process to ensure quality and relevance. The outputs can include: a training and inference engine, which is a core component for both learning from the output and making predictions or decisions based on the output; and/or data storage connectors that facilitate the interaction between the processed output and data stores.

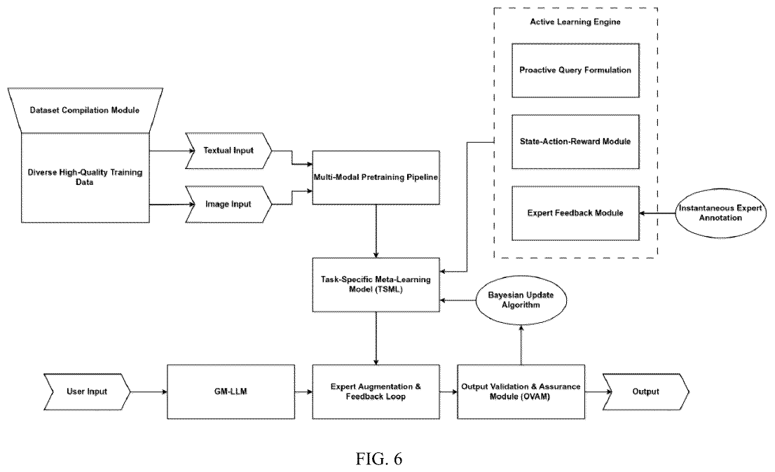

FIG. 6 shows a flow chart of a BARMI algorithm, which can be used with systems and methods of embodiments of the subject invention. The feedback loop of the BARMI methodology is described, showing how expert feedback can be combined with reinforcement learning to refine a model.

Referring to FIG. 6, the dataset compilation module can be a pipeline for gathering and organizing diverse, high-quality training data for the model's learning process. This can lead to textual input and image input. The textual preprocessing layer can handle textual input data processing to standardize and prepare it for fusion, and the image preprocessing layer can handle image input data processing to standardize and prepare it for fusion.

The BARMI algorithm can enhance the performance of GM-LLMs through an integration of Bayesian statistics, active learning, and reinforcement learning. BARMI can leverage the power of Bayesian methods to provide a robust framework for managing the uncertainty inherent in AI model training, particularly when dealing with limited or incomplete datasets. This methodology can allow for the adaptive learning of GM-LLMs while also ensuring that these models can evolve and refine their understanding in real-time, adapting to new data and expert feedback.

BARMI can operate by continuously updating the model's parameters based on the probability distributions derived from previous interactions and data, employing Bayesian inference to quantify the uncertainty in model outputs. This probabilistic approach is crucial for domains where the cost of errors is high, such as healthcare diagnostics. By actively querying the most informative data points through an entropy-based selection mechanism, BARMI can ensure that the model is learning the most from each interaction, thereby reducing the data required for achieving high accuracy. This active learning component dynamically identifies areas of the model's parameter space that are most uncertain and require expert input for clarification, effectively simulating human scenarios and incorporating pseudo-label generation into the training loop, allowing continuous improvement and reliability for high-stakes applications.

Moreover, the reinforcement learning aspect of BARMI can introduce a reward system for the model's decisions, where the system learns to optimize its actions based on the feedback loop provided by domain experts. This reinforcement learning loop not only refines the model's performance over time, but also aligns its outputs with expert knowledge and standards, ensuring both relevance and reliability in the generated content. The integration of real-time data and expert input is pivotal in aligning AI outputs with the required accuracy, making BARMI particularly advantageous in areas with complex concepts and terminologies, such as medicine, law, and pharmaceuticals.

To address the computational inefficiency of multiple EM iterations, the process can leverage a pre-trained large model with built-in reasoning and contextual understanding capabilities as the initialization point. This approach can minimize the number of iterations required to train the specialized expert model while retaining high performance and domain relevance.

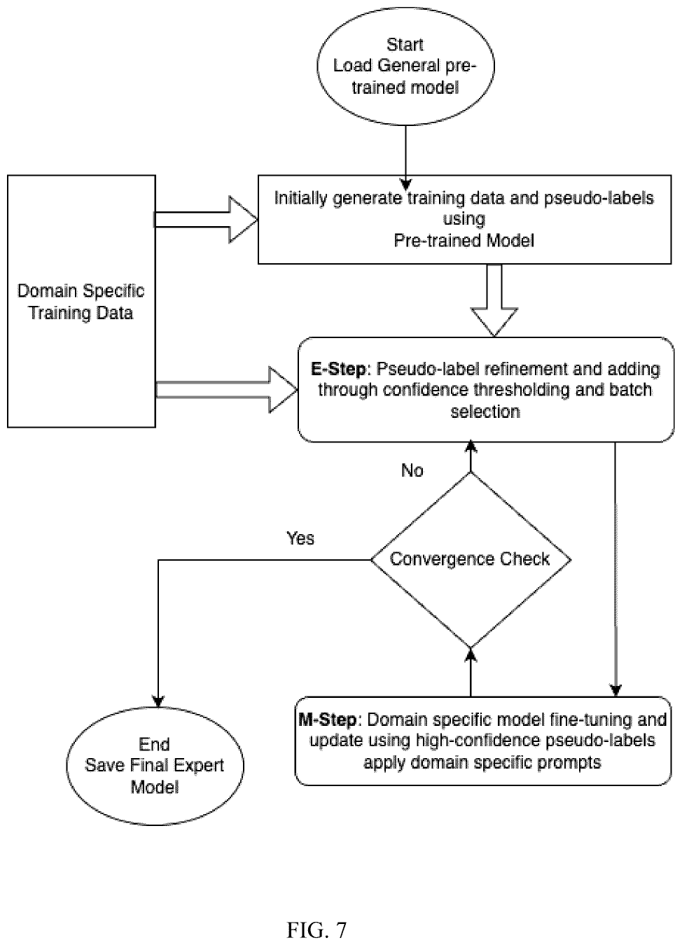

As shown in FIG. 7, the process can begin by loading a general pre-trained model, which can serve as the initialization point for the EM algorithm. This pre-trained model, already equipped with general-purpose reasoning and contextual understanding capabilities, can significantly reduce the number of iterations required for domain-specific training. The process can utilize domain-specific training data, which is fed into the system to generate an initial set of pseudo-labels using the pre-trained model. At this stage, the pre-trained model can act as M_{g}, whose parameters θ_{g} serve as the foundation for initializing the domain-specific expert model Mₑ. This can be expressed as:

θₑ⁽⁰⁾←θ_{g}

These pseudo-labels, representing predictions on the unlabeled domain-specific data, are computed as:

ŷₜ=argmax p(y∨Xᵢ,θ_{g})

Following initialization, the system can proceed to the E-step, where pseudo-label refinement is conducted using confidence thresholding and batch selection techniques. Samples with sufficiently high confidence scores C(Xᵢ) are retained, while low-confidence predictions are either skipped or flagged for further expert intervention. The confidence thresholding condition is expressed as:

maxp(y∨Xᵢ,θₑ^{(t)})<τ

To optimize computational efficiency, dynamic batch selection can prioritize samples with high uncertainty. Here, the uncertainty score for a batch is calculated as:

$$Δ {U}_{batch} = \frac{1}{B} {\sum }_{i = 1}^{B} Entropy ( {y}_{i} )$$

This can ensure that the algorithm focuses on refining the most informative pseudo-labels first. Once refined pseudo-labels are obtained, the process can transition to the M-step, during which the domain-specific model Mₑ undergoes fine-tuning. At this stage, model parameters can be updated using both the domain-specific labeled data X/and the high-confidence pseudo-labeled data Xᵤ. The optimization objective is defined as:

$${θ}_{e}^{( t + 1 )} = arg max {\sum }_{{X}_{l}} log p ( y ∨ X , θ ) + {\sum }_{{X}_{u}} {E}_{y ∼ \hat{y}} [ log p ( y ∨ X , θ ) ]$$

To enhance domain relevance, the system can employ domain-specific prompts to generate synthetic data that bridge any gaps in the dataset. This is represented as:

Xₛ=G(DomainPrompt,θₑ^{(t)})

where G is a function that generates synthetic examples tailored to the domain-specific requirements.

The algorithm can subsequently evaluate convergence through a stopping criterion based on the marginal improvement in the loss function. Convergence is achieved when the relative change in the loss L falls below a predefined threshold ϵ. This condition is expressed as:

$$Δ L = \frac{‖ {L}^{( t + 1 )} - {L}^{( t )} ‖}{{L}^{( t )}} < ϵ$$

If convergence is not satisfied, the system can iteratively return to the E-step for further pseudo-label refinement and model updates. By leveraging the reasoning-augmented pre-trained model, the total number of EM iterations T is substantially reduced compared to traditional implementations, such that:

T<<T_{traditionalEM}

The process culminates when convergence is achieved, at which point the final domain-specific expert model is saved. This optimized EM-based training pipeline can ensure efficient use of computational resources while maintaining high-quality pseudo-labels and domain relevance. Techniques such as dynamic batch selection, parallelized model updates, and task-specific regularization contribute to the algorithm's robustness, ultimately producing a fine-tuned expert model capable of capturing nuanced domain-specific patterns.

The multi-modal pretraining pipeline is a pipeline designed for initial model training, accommodating various modalities of inputs (textual and media data (e.g., image data)) to establish a broad understanding before specialized learning. The task-specific meta-learning algorithm (TSML) facilitates fine-tuning the pre-trained model on specific tasks, applying meta-learning for quick adaptation to complex tasks. The active learning engine can include: proactive query formulation that actively formulates questions or queries to gather more information or data points; the state-action-reward module, which is a core of reinforcement learning setup, where the model learns from the actions it takes based on the state of the environment and the rewards it receives; and/or the expert feedback module that allows for real-time expert feedback to be integrated into the learning process. The expert feedback module can utilize instantaneous expert annotation, which is a mechanism for experts to immediately annotate or provide feedback on the model's outputs or decisions. The expert augmentation and feedback loop is a system for incorporating human expert feedback into the model's learning process, enhancing the model's performance and reliability through human-in-the-loop collaboration. The OVAM can ensures the output is validated and meets standards or criteria of downstream tasks before being presented as output to the user. The Bayesian update algorithm block represents that the system/model can employ Bayesian statistical techniques to conduct a thorough analysis of the model's performance metrics, offering a nuanced understanding of the model's reliability and precision. Also, insights derived from continuous human feedback and Bayesian updates can be integrated into the meta-learner, bolstering its capacity to generalize across various tasks, even with sparse examples.

Embodiments of the subject invention provide systems and methods for improving the training and inference of a generative AI model (e.g., a computer-based generative AI model). A GM-LLM can be trained using a dataset that spans a variety of domains and multiple modalities, including but not limited to text, image, video, and audio. A method can include; performing initial training of the GM-LLM using a collected, multi-modal dataset; and performing subsequent fine-tuning of the GM-LLM. The fine-tuning process can be applied to the GM-LLM, specifically designed to enhance the accuracy and relevance of the outputs of the GM-LLM in specific domain applications. The method can further include executing an inference process on the trained GM-LLM to generate outputs based on multi-modal input data. Additionally, a data alignment strategy can be employed within the GM-LLM to ensure efficiency and precise processing of domain-specific data. The method can also utilize adaptive retrieval mechanisms configured to query both static knowledge bases and dynamic, real-time data sources, thereby ensuring the grounding of the model outputs in current and relevant information.

Embodiments of the subject invention include a CFEITR algorithm, which combines AI model parameters with text data, image data, and other data modalities to produce context-aware results, enhancing a generative AI model's understanding of multi-modal inputs. A contrastive similarity dual-encoder network can be included as part of the CFEITR algorithm, and this network can process text and image data in parallel, effectively mapping multi-modal inputs into a unified feature space for enhanced AI decision-making. A fusion and cross-attention layer can be included within the CFEITR algorithm, and this layer can allow the U-AI system to focus on and synthesize important features from both text and image inputs, leading to improved accuracy in information retrieval.

CFEITR can employ a two-stage process for contextual fusion. Initially, the algorithm can parse the textual query to extract and analyze semantic features. This step utilizes a textual encoder to capture the contextual nuances of the query. The encoder can generate embeddings that encapsulate the semantic content, including word meanings, syntactic structures, and subtle nuances conveyed by the language. This process can provide a rich, context-aware representation of the query, which is crucial for the subsequent stages of the algorithm.

In the next stage, visual features can be extracted from images. These features can be obtained by employing visual encoders, which are designed to capture hierarchical representations of visual information. This layer of the algorithm is responsible for processing images to derive a set of features that can interact with the textual features in a unified feature space.

CFEITR introduces an innovative hierarchical token fusion mechanism (HTFM), a novel approach to cross-modality fusion that can enable fine-grained interactions between textual and visual data. HTFM can process inputs as semantic textual tokens and hierarchically-quantized visual tokens that are dynamically projected into a unified latent interaction space. These tokens can act as elemental units of information, preserving modality-specific granularity while enabling alignment across modalities.

HTFM can operate through a two-step process. First, visual information can be hierarchically transformed into a set of compact, information-dense tokens that capture low-level details alongside higher-level abstract representations. Then, the textual modality can be tokenized into semantically-rich units that encapsulate nuanced word meanings, syntactic structures, and contextual intent. Both token sets can be projected into a unified latent space where cross-modal interactions occur.

To facilitate precise and adaptive interactions between these tokens, HTFM can employ a dynamic token attention network (DTAN), which can enhance conventional cross-attention mechanisms by introducing adaptive attention modulation. Rather than applying a static, uniform attention strategy across all tokens, DTAN can allow for unique attention patterns, tailored to the context of the query and the relationships between tokens.

DTAN can operate by evaluating both intra-modal and cross-modal relevance at the token level. During cross-attention, DTAN can dynamically modulate attention weights based on the unified position of tokens, ensuring that interactions are properly contextualized.

To further enhance the alignment between the textual and visual features, CFEITR can incorporate a contrastive loss mechanism during the training of the multi-modal embedding model. This technique aims to bring similar pairs of text-image combinations closer together while pushing dissimilar pairs apart in the feature space. By optimizing this loss, the algorithm can learn to create embeddings where related content is clustered and unrelated content is separated, improving the semantic relevance of retrieved results.

The TSML can incorporate reinforcement learning (RL) to dynamically optimize model adaptation, improve task-specific fine-tuning, and enhance proactive query generation. This integration can allow the system to learn a policy for selecting optimal learning strategies, data points, and task-specific adaptations.

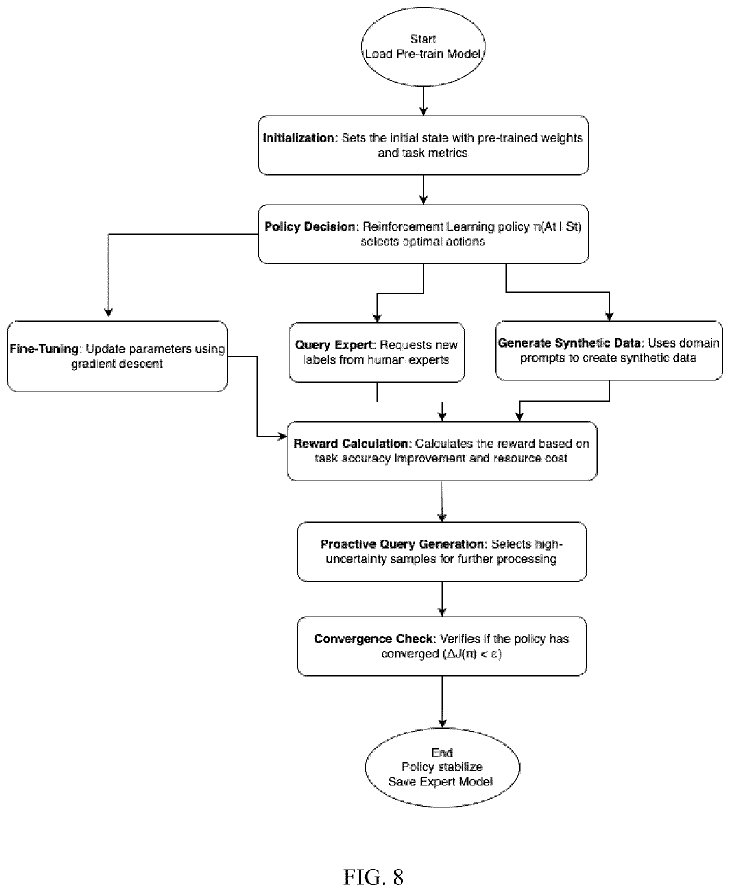

FIG. 8 shows a visual representation of the TSML algorithm with RL integration, showing a systematic process for task-specific model adaptation and optimization. The workflow begins with the initialization phase, where the model parameters are loaded using pre-trained weights. This establishes the initial state, defined as S₀, comprising the pre-trained parameters, task data, and performance metrics.

The subsequent step involves the RL policy decision, where the policy π(Aₜ|Sₜ) is applied to dynamically select optimal actions. These actions include fine-tuning the model, querying experts for additional labels, and/or generating synthetic data to augment the training dataset.

During the fine-tuning phase, the model parameters can be iteratively updated based on the gradient of the task-specific loss Lₜₐₛₖ. The loss function is expressed as:

Lₜₐₛₖ=E₍ₓ_{ₜ}_{,y}_{ₜ}₎[log p(yₜ∨Xₜ,θₛ)]

where θₛ are the current model parameters, Xₜ is the input data, and yₜ represents the target labels. Fine-tuning can ensure continuous performance improvement while adapting to task-specific requirements.

If the policy deems it beneficial, the query expert action can be invoked, which requests additional labels for highly uncertain or informative data points. This step can optimize resource usage by focusing on critical data points that maximize learning gain. In parallel, the synthetic data generation step can produce augmented data using domain-specific prompts and a generation function further improving the model's adaptability to the task.

The reward calculation phase can evaluate the outcome of the selected actions, where the reward Rₜ is formulated as:

$${R}_{t} = Δ TaskAccuracy - β \cdot ResourceCost$$

Here, ΔTask Accuracy can measure the improvement in task performance, while β is a scaling factor that penalizes resource consumption. This reward can guide the RL policy to favor actions that strike a balance between performance enhancement and resource efficiency.

The proactive query generation component can identify high-uncertainty samples or those with the highest expected rewards using:

$$Q ( x ) = max {E}_{π} [ {R}_{t} ∨ {S}_{t} = x ]$$

These samples can be prioritized for further processing, reducing labeling costs and maximizing learning efficiency.

The final step involves a convergence check, where the algorithm can verify whether the policy has stabilized by assessing the change in expected cumulative reward. Convergence is defined as:

$$Δ J ( π ) = \vert {E}_{π} [ {\sum }_{t = 0}^{T} {R}_{t}^{( t + 1 )} ] - {E}_{π} [ {\sum }_{t = 0}^{T} {R}_{t}^{( t )} ] \vert < ϵ$$

Once this condition is met, the policy stabilizes, and the final task-specific model can be saved as an expert model.

The RL-enhanced TSML algorithm introduces dynamic adaptation, enabling models to adjust to changing tasks and data distributions. Proactive query optimization can reduce labeling costs by focusing on key data points, while cost-aware training balances performance with resource efficiency. Action diversity explores strategies like synthetic data generation and fine-tuning for robust adaptation. This algorithm can offer improved efficiency by prioritizing high-impact actions, consistent task performance, scalable learning across domains, and/or optimal resource utilization.

Embodiments of the subject invention can also include a BARMI algorithm, which can actively train the U-AI system with new data and expert feedback, fine-tuning the generative AI model's performance in real time.

In embodiments of the subject invention, an expert augmentation and feedback loop can be used and can incorporate human expert feedback into the U-AI system, refining model accuracy and ensuring adherence to complex domain-specific tasks. An OVAM within the U-AI system can validate the AI-generated outputs against established criteria, ensuring compliance with professional standards before user presentation. A DIM can provide the U-AI system with different connectivity to a variety of database systems, enabling seamless interaction through a unified API. An RTSC can facilitate the U-AI system's access to real-time data feeds, ensuring that the AI model operates on up-to-date and relevant data for its tasks. A KGN can be used and can enable the U-AI system to traverse through complex knowledge graphs, enriching the generative AI's outputs with subtle context and relationships between data points. An expert ruleset verification layer can align the U-AI system's outputs with a set of pre-defined expert rules or standards, maintaining domain-specific accuracy and integrity. A relevance scoring algorithm can assess and scores the relevance of AI-generated results against user queries, ensuring the outputs meet information requirements of the user. A distributed query execution module can be capable of handling the execution of queries across various databases and systems, optimizing the U-AI system's access to distributed data sources. A real-time data pre-processor can condition streaming data for immediate integration into the U-AI system, supporting the generative AI model's need for real-time information. A stream-to-database transfer manager can oversee the transfer of real-time data into systematic storage, bridging the gap between live data streams and structured database records. A knowledge validation layer can apply a set of sophisticated algorithms to verify the AI's outputs against established knowledge graphs and expert rulesets, ensuring the fidelity and accuracy of results. A Bayesian analysis algorithm can be used, and it can utilize statistical techniques for updating the U-AI system's understanding based on performance metrics and human feedback, continually refining the AI model's predictive confidence and accuracy.

In an embodiment, a method can create knowledge graph's content based on user input content such as documents, images, and expert knowledge guideline and rule sets.

Embodiments of the subject invention address the inefficiency of current Large Language Models (LLMs) in specialized, domain-specific applications, and their inability to effectively integrate and process multi-modal data (e.g., text, images, voice) across diverse sectors. This is done by uniquely integrating GM-LLMs with an advanced RAG framework and a custom fine-tuning mechanism. This not only enhances data processing accuracy but also ensures real-time applicability and adaptability across various domains, surpassing the current “gold standard” by facilitating more relevant and safer AI-generated responses.

Embodiments of the subject invention address the pressing need of generative AI that is capable of navigating the complexities of specialized domains with an accuracy and reliability comparable to that of human experts. Embodiments exemplify the transformative potential of AI when enhanced with suitable tools, methodologies, and data, across complex and demanding sectors (e.g., healthcare, radiology, chemistry, pharmaceuticals, and supply chain logistics).

Embodiments of the subject invention provide a focused technical solution to the focused technical problem of how to overcome the inefficiency of current LLMs in specialized applications. The solution is provided by integrating GM-LLMs with an advanced RAG framework and a custom fine-tuning mechanism. Embodiments of the subject invention can improve the computer system utilized for the solution by increasing the accuracy of LLMs.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When the term module is used herein, it can refer to software and/or one or more algorithms to perform the function of the module; alternatively, the term module can refer to a physical device configured to perform the function of the module (e.g., by having software and/or one or more algorithms stored thereon).

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including in the “References” section, if present) are incorporated by reference in their entirety, including all figures and tables, to the extent they are not inconsistent with the explicit teachings of this specification.

What is claimed is:

1. A system for training and inference of a generative artificial intelligence (AI) model, the system comprising:
a processor; and
a machine-readable medium in operable communication with the processor and having instructions stored thereon that, when executed by the processor, perform the following steps:
a) training a generative multi-modal large language model (GM-LLM) using a first dataset to obtain a trained GM-LLM, wherein the first dataset has been processed using a contextual fusion for enhanced image-text retrieval (CFEITR) algorithm to synthesize features across a plurality of modalities using a fusion and cross-attention layer, thereby obtaining the trained GM-LLM with a contextual understanding of text input, image input, video input, and audio input;
b) performing fine-tuning on the trained GM-LLM using a task-specific meta-learning algorithm to obtain a fine-tuned GM-LLM that is configured for expert-driven augmentation and active learning; and
c) performing an inference process on the fine-tuned GM-LLM using knowledge graph-enhanced retrieval and a Bayesian active reinforcement learning for multi-modal improvement (BARMI) algorithm to dynamically validate outputs against at least one expert rule set and/or at least one knowledge base, to obtain the generative AI model.

2. The system according to claim 1, wherein the plurality of modalities comprises at least one of text, image, video, and audio.

3. The system according to claim 1, wherein the plurality of modalities comprises all of text, image, video, and audio.

4. The system according to claim 1, wherein the instructions when executed further perform the following step:
d) before step c), incorporating an adaptive retrieval mechanism into the GM-LLM, the trained GM-LLM, or the fine-tuned GM-LLM, wherein the adaptive retrieval mechanism is configured to query both static knowledge bases and dynamic, real-time data sources,
wherein the adaptive retrieval mechanism is further configured to re-rank responses using a multi-layered relevance scoring system, and
wherein the adaptive retrieval mechanism is further configured to filter outputs using domain-specific constraints and expert rules.

5. The system according to claim 4, wherein the adaptive retrieval mechanism is implemented using a retrieval augmented generation (RAG) architecture that comprises a dynamic query expansion model, multi-modal contrastive retrieval techniques, and task-adaptive embeddings for knowledge search.

6. The system according to claim 1, wherein the instructions when executed further perform the following step:
e) before step a), using the CFEITR algorithm on the first dataset to extract cross-modality semantic features, to filter training inputs using multi-modal consistency validation, and to obtain a context-aware first dataset, which is used for training the GM-LLM in step a).

7. The system according to claim 6, wherein the CFEITR algorithm comprises a fusion and cross-attention layer that synthesizes important features from different modalities in the first dataset.

8. The system according to claim 1, wherein step a) comprises using an expert augmentation and feedback loop, wherein human expert feedback is incorporated using an interactive Bayesian active reinforcement learning framework to iteratively improve a multimodal understanding of the GM-LLM and performance metrics of the GM-LLM.

9. The system according to claim 1, wherein step a) comprises using an output validation and assurance module (OVAM) that validates AI-generated outputs against established criteria.

10. The system according to claim 1, wherein the instructions when executed further perform the following step:
f) providing connectivity to a plurality of database systems using a database integration module (DIM) via a unified application programming interface (API).

11. The system according to claim 1, wherein the instructions when executed further perform the following step:
g) providing a real-time streaming connector (RTSC) that provides access to real-time data feeds.

12. The system according to claim 1, wherein the instructions when executed further perform the following step:
h) providing a knowledge graph navigator (KGN) that enables the generative AI model to traverse through a plurality of knowledge graphs.

13. The system according to claim 12, wherein the instructions when executed further perform the following step:
i) creating content of the plurality of knowledge graph based on user input and expert knowledge rule sets.

14. The system according to claim 1, wherein step b) comprises the BARMI algorithm to actively train and fine-tune the GM-LLM in real time with new data and expert feedback.

15. The system according to claim 1, wherein step b) comprises using a Bayesian analysis algorithm utilizing statistical techniques to fine-tune the trained GM-LLM based on performance metrics and user feedback.

16. The system according to claim 1, wherein step b) comprises using an expert ruleset verification layer that aligns outputs of the generative AI model with a set of pre-defined expert rules or standards.

17. The system according to claim 1, wherein the instructions when executed further perform the following step:
j) using a relevance scoring and rewarding algorithm, wherein the relevance scoring and rewarding algorithm combines semantic similarity metrics, contextual relevance weights, and a reinforcement learning reward system to optimize outputs of the generative AI model in response to user queries.

18. The system according to claim 1, wherein the instructions when executed further perform the following step:
k) using a distributed query execution module to handle execution of queries to the generative AI model across a plurality of databases by parallelizing multi-source queries across structured and unstructured datasets, and optimizing response latency using adaptive load balancing.

19. The system according to claim 1, wherein the instructions when executed further perform the following step:
l) using a real-time data pre-processor to condition streaming data for immediate input into the generative AI model.

20. The system according to claim 1, further comprising a storage memory in operable communication with the processor,
wherein the instructions when executed further perform the following steps:
m) using a stream-to-database transfer manager to transfer real-time data into the storage memory; and
using a knowledge validation layer to apply a set of algorithms to verify outputs of the generative AI model against established knowledge graphs and expert rulesets.

21. The system according to claim 1, wherein the instructions when executed further perform the following step:
n) using a knowledge validation layer to apply a set of algorithms to verify outputs of the generative AI model against established knowledge graphs and expert rulesets.

22. A method for training and inference of a generative artificial intelligence (AI) model, the method comprising:
a) training a generative multi-modal large language model (GM-LLM) using a first dataset to obtain a trained GM-LLM, wherein the first dataset has been processed using a contextual fusion for enhanced image-text retrieval (CFEITR) algorithm to synthesize features across a plurality of modalities using a fusion and cross-attention layer, thereby obtaining the trained GM-LLM with a contextual understanding of text input, image input, video input, and audio input;
b) performing fine-tuning on the trained GM-LLM using a task-specific meta-learning algorithm to obtain a fine-tuned GM-LLM that is configured for expert-driven augmentation and active learning; and
c) performing an inference process on the fine-tuned GM-LLM using knowledge graph-enhanced retrieval and a Bayesian active reinforcement learning for multi-modal improvement (BARMI) algorithm to dynamically validate outputs against at least one expert rule set and/or at least one knowledge base, to obtain the generative AI model.

23. The method according to claim 22, wherein the plurality of modalities comprises at least one of text, image, video, and audio.

24. The method according to claim 22, wherein the plurality of modalities comprises all of text, image, video, and audio.

25. The method according to claim 22, further comprising:
d) before step c), incorporating an adaptive retrieval mechanism into the GM-LLM, the trained GM-LLM, or the fine-tuned GM-LLM, wherein the adaptive retrieval mechanism is configured to query both static knowledge bases and dynamic, real-time data sources,
wherein the adaptive retrieval mechanism is further configured to re-rank responses using a multi-layered relevance scoring system, and
wherein the adaptive retrieval mechanism is further configured to filter outputs using domain-specific constraints and expert rules.

26. The method according to claim 25, wherein the adaptive retrieval mechanism is implemented using a retrieval augmented generation (RAG) architecture that comprises a dynamic query expansion model, multi-modal contrastive retrieval techniques, and task-adaptive embeddings for knowledge search.

27. The method according to claim 22, further comprising:
e) before step a), using the CFEITR algorithm on the first dataset to extract cross-modality semantic features, to filter training inputs using multi-modal consistency validation, and to obtain a context-aware first dataset, which is used for training the GM-LLM in step a).

28. The method according to claim 27, wherein the CFEITR algorithm comprises a fusion and cross-attention layer that synthesizes important features from different modalities in the first dataset.

29. The method according to claim 22, wherein step a) comprises using an expert augmentation and feedback loop, wherein human expert feedback is incorporated using an interactive Bayesian active reinforcement learning framework to iteratively improve a multimodal understanding of the GM-LLM and performance metrics of the GM-LLM.

30. The method according to claim 22, wherein step a) comprises using an output validation and assurance module (OVAM) that validates AI-generated outputs against established criteria.

31. The method according to claim 22, further comprising:
f) providing connectivity to a plurality of database systems using a database integration module (DIM) via a unified application programming interface (API).

32. The method according to claim 22, further comprising:
g) providing a real-time streaming connector (RTSC) that provides access to real-time data feeds.

33. The method according to claim 22, further comprising:
h) providing a knowledge graph navigator (KGN) that enables the generative AI model to traverse through a plurality of knowledge graphs.

34. The method according to claim 33, further comprising:
i) creating content of the plurality of knowledge graph based on user input and expert knowledge rule sets.

35. The method according to claim 22, wherein step b) comprises using the BARMI algorithm to actively train and fine-tune the GM-LLM in real time with new data and expert feedback.

36. The method according to claim 22, wherein step b) comprises using a Bayesian analysis algorithm utilizing statistical techniques to fine-tune the trained GM-LLM based on performance metrics and user feedback.

37. The method according to claim 22, wherein step b) comprises using an expert ruleset verification layer that aligns outputs of the generative AI model with a set of pre-defined expert rules or standards.

38. The method according to claim 22, further comprising:
j) using a relevance scoring and rewarding algorithm, wherein the relevance scoring and rewarding algorithm combines semantic similarity metrics, contextual relevance weights, and a reinforcement learning reward system to optimize outputs of the generative AI model in response to user queries.

39. The method according to claim 22, further comprising:
k) using a distributed query execution module to handle execution of queries to the generative AI model across a plurality of databases by parallelizing multi-source queries across structured and unstructured datasets, and optimizing response latency using adaptive load balancing.

40. The method according to claim 22, further comprising:
l) using a real-time data pre-processor to condition streaming data for immediate input into the generative AI model.

41. The method according to claim 22, further comprising:
m) using a stream-to-database transfer manager to transfer real-time data into a storage memory.

42. The method according to claim 22, further comprising:
n) using a knowledge validation layer to apply a set of algorithms to verify outputs of the generative AI model against established knowledge graphs and expert rulesets.
